(19) United States
(12) Patent Application Publication
(10) Pub. No.: US 2024/0250358 A1
(43) Pub. Date: Jul. 25, 2024

(54) METHOD OF PRODUCING A BATTERY MODULE AND BATTERY MODULE

(71) Applicant: Robert Bosch GmbH, Stuttgart (DE)

(72) Inventors: Ruben Jung, Stuttgart (DE); Jens-Martin Koegel, Stuttgart (DE); Joerg Nils Illig, Markgroeningen (DE); Klaus Spieske, Stuttgart (DE); Knut Hanke, Neuhausen (DE); Martin Kassner, Weil Der Stadt (DE)

(21) Appl. No.: 18/413,356

(22) Filed: Jan. 16, 2024

(30) Foreign Application Priority Data
Jan. 24, 2023 (DE) 10 2023 200 538.7

(51) Int. Cl. H01M 50/204; H01M 10/0525

(52) U.S. Cl. CPC H01M 50/204; H01M 10/0525

(57) ABSTRACT

A method for producing a battery module, having a plurality of prismatic battery cells and/or a plurality of battery cells in the form of pouch cells, includes in a first method step detecting a width of a battery cell when a defined force is applied to the respective battery cell. In a second method step, the plurality of battery cells are arranged adjacent to one another in a longitudinal direction of the battery module, and a compensating element is arranged between two battery cells arranged directly adjacent to one another. A width of the compensating element is formed in such a way that a sum of the widths of the two battery cells arranged directly adjacent to one another and the width of the compensating element has a defined value, so that ultimately the battery module has a defined overall width.

### BACKGROUND

The disclosure is based on a method for producing a battery module. Another object of the present disclosure is a battery module.

It is known from the prior art that a battery module has a plurality of individual battery cells, each having a positive voltage tap and a negative voltage tap, wherein for an electrically conductive serial and/or parallel connection of the plurality of battery cells to one another, the respective voltage taps are electrically conductively connected to one another and can thus be interconnected to form the battery module. In particular, the battery cells can each comprise a first voltage tap, in particular a positive voltage tap, and a second voltage tap, in particular a negative voltage tap, which taps are electroconductively connected to one another by means of cell connectors so that an electroconductive serial and/or parallel circuitry is formed. Battery modules are themselves in turn interconnected into batteries or entire battery systems.

### SUMMARY

A method for producing a battery module with the features of the disclosure offers the advantage that a defined overall width of the battery module can be formed, in particular even if the battery cells each have a different width when used in the battery module.

According to the invention, a method for producing a battery module with a plurality of prismatic battery cells and/or a plurality of battery cells in the form of pouch cells is provided for this purpose. In particular, the battery cells are designed as lithium-ion battery cells.

In a first method step, the width of a battery cell is recorded when a defined force is applied to the respective battery cell.

Furthermore, in a second method step, the plurality of battery cells is arranged adjacent to each other in a longitudinal direction of the battery module. A compensating element is also arranged between two directly adjacent battery cells. A width of the compensating element is formed in such a way that a sum of the widths of the two battery cells arranged directly adjacent to each other and the width of the compensating element has a defined value, so that the battery module ultimately has a defined overall width.

In particular, the first method step of detecting the width of a battery cell when the defined force is applied to this respective battery cell can take place before and, among other things, spatially separated from the second method step of arranging the plurality of battery cells adjacent to one another in a longitudinal direction of the battery module and arranging the compensating element between two battery cells arranged directly adjacent to one another and forming the compensating element. For example, the first method step could be carried out at a manufacturer or supplier of the battery cells. It should also be noted that the width of each battery cell is preferably recorded when the defined force is applied.

Furthermore, the second method step could, for example, be carried out at a manufacturer or supplier of the battery module. It should also be noted that the width of each battery cell is preferably read out.

It should at this point be noted that prismatically formed battery cells each comprise a battery cell housing having a total of six lateral surfaces, which are arranged in pairs opposite each other and substantially parallel to each other. In addition, lateral surfaces arranged adjacent one another are arranged perpendicular to one another. The electrochemical components of the respective battery cell are accommodated within the interior of the battery cell housing. Typically, two voltage taps, in particular a positive voltage tap and a negative voltage tap, are arranged on an upper lateral surface, which is referred to as the cover surface. The lower lateral surface opposite the upper lateral surface is referred to as the bottom surface.

It should also be noted at this point that in battery cells designed as pouch cells, which can also be referred to as pouch cells in particular, a film encloses an interior in which the electrochemical components of the respective battery cell are accommodated. Two voltage taps, in particular a positive voltage tap and a negative voltage tap, are fed through this foil from the inside. Such battery cells designed as pouch cells also essentially have six lateral surfaces.

Furthermore, it should be noted in this respect that when the battery cells are arranged next to each other in a longitudinal direction of the battery module, the battery cells are arranged adjacent to each other with their respective largest lateral surfaces, which are each arranged in particular at right angles to the upper lateral surface and the lower lateral surface. It should be noted at this point that the longitudinal direction of the battery module in this case is therefore advantageously arranged perpendicular to the largest lateral surfaces of the respective battery cells.

It should also be noted that the width of a respective battery cell is preferably the distance between the two largest lateral surfaces. In other words, this width could also be referred to as the thickness of a battery cell, for example.

The force acting on the battery cell in order to detect the width of this battery cell when such a defined force is applied to this battery cell is preferably selected in particular in such a way that this force corresponds to a force acting on the battery cell when it is arranged in a battery module as a result of mechanical tension and/or chemical ageing processes.

Furthermore, the force which acts on the battery cell in order to detect the width of this battery cell when such a defined force is applied to this battery cell can preferably be selected in particular in such a way that air pockets and/or cavities in an interior of the battery cell are compensated for or compressed.

It is useful if the defined force acts on the largest lateral surfaces of the respective battery cell. This makes it possible to reliably measure and thus record the width of each battery cell.

It is also useful if the defined force is applied by means of two plates. The respective battery cell, the width of which is to be detected when the defined force is applied, is arranged between the two plates. This allows the defined force to be applied reliably. It should be noted at this point that the force can be applied by means of both plates being actively moved towards each other, or that the force can be actively applied to another stationary plate by means of the movement of one of the plates. In particular, the two plates in each case could be planar and arranged parallel to each other. Furthermore, the two plates can in particular also comprise any geometric configuration, such as a pressed geometry, in which, for example, the battery cell can be accommodated.

It is advantageous if, in the first method step, the respective width of a battery cell is also stored as belonging to this respective battery cell and, in the second method step, the width of a battery cell is also read out and assigned to this respective battery cell. This can further support the temporal separation and spatial separation of the first method step and the second method step in such a way that a direct and unambiguous assignment of a correct width to the battery cell is always possible.

It is advantageous if the width of a battery cell is stored in a database or on the battery cell. This can further improve the reliable, direct and unambiguous assignment of a correct width to the battery cell. For example, when the defined force is applied, the width of the battery cell together with the defined force could be applied to the packaging of the battery cell or directly to the housing of the battery cell.

According to a preferred aspect of the invention, compensating elements are arranged with different widths.

A first compensating element with a first width is arranged between two battery cells whose widths form a first sum.

Furthermore, a second compensating element with a second width is arranged between two battery cells whose widths form a second sum. Here, the first sum is greater than the second sum and the first width is smaller than the second width.

This makes it possible to select the compensating element depending on the detected widths of the two battery cells arranged directly adjacent to each other. In particular, the compensating element can be designed in such a way that a comparably thinner compensating element is arranged between comparably thicker battery cells, and that a comparably thicker compensating element can be arranged between comparably thinner battery cells.

It should be noted at this point that the number of compensating elements with different widths can comprise, for example, two or three different compensating elements. In particular, the number of compensating elements with different widths can also be adapted to production-related deviations in the detected widths of the battery cells when the defined force is applied, so that, for example, a comparably larger number of different compensating elements can be selected when a comparably large number of different widths of the battery cells are detected.

For example, the different compensating elements could also be selected in such a way that an average width of all compensating elements is formed.

According to another preferred aspect of the invention, compensating elements are arranged with identical widths. First, a total width is determined, which is formed as the sum of all recorded widths of the plurality of battery cells. This determined total width is then subtracted from the defined total width of the battery module. Finally, the identical widths are divided identically into the resulting difference. In other words, this means that to determine the identical width, the resulting difference is divided by the number of compensating elements.

According to yet another preferred aspect of the invention, forming the overall width further comprises calculating an average width. At this point, it should be noted that the average width corresponds to the total sum of all recorded widths of the battery cells divided by the number of battery cells. Furthermore, the total width is calculated as the product of the average width and the number of battery cells.

At this point, it should be noted in particular that the defined value, which is the sum of the widths of the two battery cells arranged directly adjacent to each other and the width of the compensating element, is selected in such a way that the battery module ultimately has a desired overall width.

Another object of the present invention is a battery module with a plurality of battery cells, which are designed in particular as lithium-ion battery cells. The battery module is produced according to the method of the invention just described.

It should also be noted at this point that the battery cells can also be designed as sodium-ion battery cells.

### BRIEF DESCRIPTION OF THE DRAWINGS

Embodiment examples of the invention are illustrated in the drawings and explained in greater detail in the subsequent description.

The drawings show:

FIG. 1 a first method step of a method according to the invention for producing a battery module,

FIG. 2 an embodiment of a first battery module according to the invention after carrying out a second method step and

FIG. 3 an embodiment of a second battery module according to the invention after carrying out a second method step.

### DETAILED DESCRIPTION

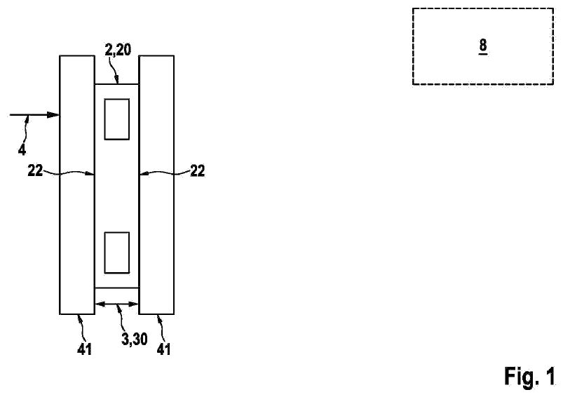

FIG. 1 shows a first method step of a method according to the invention for producing a battery module 1.

First of all, a prismatic battery cell 2 can be seen, which, according to the embodiment example shown in FIG. 1, is designed in particular as a lithium-ion battery cell 20.

In the first method step shown in FIG. 1, a width 3 of the battery cell 2 is detected when a defined force 4 is applied to this battery cell 2. The battery cell 2 shown in FIG. 1 has a width 30 when the defined force 4 is applied.

In particular, it can be seen from FIG. 1 that the defined force 4 in each case acts on the largest lateral surfaces 22 of the battery cell 2. In particular, the defined force 4 can preferably be applied by means of two plates 41. The battery cell 2 is arranged between the two plates 41.

Furthermore, in such a first method step, the respective width 30 of the battery cell 2 is stored associated with this respective battery cell 2. For example, the width 30 associated with this battery cell 2 can be stored in a database 8 and/or also preferably directly on the battery cell 2.

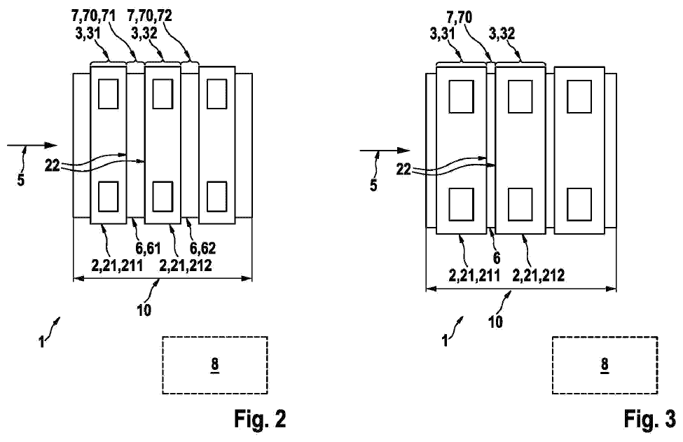

FIG. 2 shows an embodiment of a first battery module 1 according to the invention with a plurality of battery cells 2 after carrying out a second method step, and FIG. 3 shows an embodiment of a second battery module 1 according to the invention with a plurality of battery cells 2 after carrying out a second method step.

FIGS. 2 and 3 are largely described together below.

It can be seen that the plurality of battery cells 2 are arranged adjacent to each other in a longitudinal direction 5 of the respective battery module 1. In particular, the battery cells 2 in each case are arranged with their largest lateral surfaces 22 adjacent to each other.

Furthermore, a compensating element 6, which has a width 7, is arranged between two battery cells 21 arranged directly adjacent to each other. FIGS. 2 and 3 also show that in each case a further compensating element 7 can be arranged adjacent to opposite terminal battery cells 2.

The width 7 of the compensating element 6 is designed in such a way that the sum of the widths 3 of the two battery cells 21 arranged directly adjacent to each other and the width 7 of the compensating element 6 has a defined value. In particular, for example, a first battery cell 211 of the two battery cells 21 arranged directly adjacent to one another has a first width 31 and, for example, a second battery cell 212 of the two battery cells 21 arranged directly adjacent to one another has a second width 32. Furthermore, it should be noted in particular that the width 7 of the compensating element 6 corresponds to the distance between the largest lateral surfaces 22 of the two battery cells 21 arranged directly adjacent to each other.

In particular, the width 30, 31, 32 of a battery cell 2, 211, 212 can be read out in the second method step and assigned to this respective battery cell 2, for example from a database 8.

In particular, FIGS. 2 and 3 each show that compensating elements 6 are arranged with identical widths 70. For this purpose, a total width is first determined, which is formed as the sum of all widths 3 of the plurality of battery cells 2. This determined or formed total width is then subtracted from a defined or desired total width 10 of the battery module 1.

Finally, the identical widths 70 are divided identically or evenly into the resulting difference.

It should be noted at this point that the formation of the total width can also comprise the calculation of an average width 3 of the plurality of battery cells 2. Furthermore, the total width is then calculated as the product of the average widths 3 and the number of battery cells 2.

The embodiments of the battery module 1 according to the invention shown in FIGS. 2 and 3 differ in particular in that the battery cells 2 of the battery module 1 according to FIG. 1 have a smaller average width 3 than the battery cells 2 of the battery module 1 according to FIG. 2. As a result, the compensating elements 6 of the battery module 1 according to FIG. 1 have a greater width 7 than the compensating elements 6 of the battery module 1 according to FIG. 2.

Furthermore, the battery module 1 according to FIG. 1 and the battery module 1 according to FIG. 2 each have an identical overall width 10 of the battery module 10.

The battery modules 1 shown in FIGS. 2 and 3 in each case have been produced using a method according to the invention.

At this point, it should also be noted that the compensating elements 6 of a battery module 1 can also have different widths 7. For this purpose, a first compensating element 61 with a first width 71 is arranged in particular between two battery cells 21 arranged directly adjacent to one another, the widths 3 of which form a first sum. Furthermore, a second compensating element 62 with a second width 72 is arranged in particular between two battery cells 21 arranged directly adjacent to one another, the widths 3 of which form a second sum.

Here, the first sum is greater than the second sum and the first width 71 is smaller than the second width 72. FIG. 1 shows at least the reference numbers of one such embodiment.

1. A method for producing a battery module (1) having a plurality of prismatic battery cells (2) and/or a plurality of battery cells (2) in the form of pouch cells,
wherein, in a first method step, a width (3, 30) of a battery cell (2) is detected when a defined force (4) is applied to a respective battery cell (2), and
wherein, in a second method step, the plurality of battery cells (2) is arranged adjacent to one another in a longitudinal direction (5) of the battery module (1), and
furthermore, a compensating element (6) is arranged between two battery cells (21) that are arranged directly adjacent to one another, wherein
a width (7) of the compensating element (6) is formed in such a way that a sum of the widths (3) of the two battery cells (21) arranged directly adjacent to one another and the width (7) of the compensating element (6) has a defined value, so that the battery module (1) has a defined overall width (10).

2. The method according to claim 1, wherein the defined force (4) acts on largest lateral surfaces (22) of a respective battery cell (2).

3. The method according to claim 1, wherein the defined force (4) is applied by two plates (41), wherein the respective battery cell (2) is arranged between the two plates (41).

4. The method according to claim 1, wherein
in the first method step, the width (30) of the battery cell (2) is stored, and
in the second method step, the width (30) of a battery cell (2) is read out and assigned to the respective battery cell (2).

5. The method according to claim 4, wherein the width (30) of a battery cell (3) is stored in a database (8) or on the battery cell (2).

6. The method according to claim 1, wherein compensating elements (6) with different widths (7) are used,
wherein between two battery cells (2) whose widths (3, 31, 32) form a first sum, a first compensating element (61) with a first width (71) is arranged, and
wherein between two battery cells (2) whose widths (3, 31, 32) form a second sum, a second compensating element (62) with a second width (72) is arranged,
wherein the first sum is greater than the second sum and the first width (71) is smaller than the second width (72).

7. The method according to claim 1, wherein compensating elements (6) with identical widths (70) are used,
wherein a total width is formed as a sum of all widths (3) of the plurality of battery cells (2), and then
the total width is subtracted from the defined total width (10) of the battery module (1), and finally
the identical widths (70) are distributed identically over a resulting difference.

8. The method according to claim 7, wherein the formation of the total width further comprises a calculation of an average width (3), and
the total width is calculated as a product of the average width (3) and the number of battery cells (2).

9. A battery module with a plurality of battery cells (2), produced according to the method of claim 1.

10. The method according to claim 1, wherein the plurality of battery cells are lithium-ion battery cells (20).
